(19) United States
(12) Patent Application Publication
(10) Pub. No.: US 2016/0009930 A1
(43) Pub. Date: Jan. 14, 2016

(54) RADIO FREQUENCY INDENTIFICATION (RFID) INK

(71) Applicant: PATRICK PAGANI, CLIFTON, NJ (US)

(72) Inventor: PATRICK PAGANI, CLIFTON, NJ (US)

(21) Appl. No.: 14/326,839

(22) Filed: Jul. 9, 2014

(51) Int. Cl. C09D 11/02; C09D 7/12

(52) U.S. Cl. CPC C09D 11/02; C09D 7/12

(57) ABSTRACT

A RFID ink is described. The RFID ink includes a paste containing a pigment. A plurality of micro-RFID tags is dispersed in the paste. Each of the micro-RFID tags includes an integrated circuit (IC) having a memory and an antenna coupled to the IC. The plurality of micro-RFD tags can be dispersed substantially uniformly through the paste.

### TECHNICAL FIELD

The present invention relates generally to radio frequency identification (RFID) technology and more specifically to micro-RFID tags.

### BACKGROUND

Recent advances in semiconductor processing have led to increasingly smaller integrated circuits (ICs). For example, one device that has benefited from these advances is the radio frequency identification (RFID) tag. A typical RFID tag has a small IC that is electrically connected to an antenna. When a RFID reader is positioned proximate to the RFID tag, the electrical energy emitted by the reader excites the antenna which generates a small current that energizes the IC in the RFID tag. The RFID tag transmits data stored in a memory of the IC through the antenna to the RFID reader. The IC in the RFID tag can be programmed with various product codes or other data that can be used to identify the object to which the RFID tag is associated.

### SUMMARY OF THE INVENTION

In one aspect, the invention is embodied in an ink. The ink includes a paste containing a pigment. A plurality of micro-RFID tags is dispersed in the paste. Each of the micro-RFID tags include an integrated circuit (IC) having a memory and an antenna coupled to the IC, In alternate embodiments, the color of the pigment can be cyan, magenta, yellow, black, or a color from the Pantone® color palette. The color of the pigment can correspond to a brand.

In one embodiment, the paste can also include at least one of a binding agent, coalescing agent, wetting agent, and a carrier substance. The paste can be adapted for use in a lithographic printing process.

Each of the plurality of micro-RFID tags can also include an impedance matching circuit positioned in the antenna for matching impedance between the IC and the antenna. In one embodiment, information in the memory is readable by a RFID reader positioned proximate to the ink. The plurality of micro-RFID tags can be dispersed substantially uniformly in the paste. The memory can contain predetermined information. In one embodiment, the largest dimension of each of the plurality of micro-RFID tags is less than 0.75 mm.

In another aspect, the invention is embodied in a method for manufacturing an ink. The method can include the step of adding a pigment to a paste. A plurality of micro-RFID tags can be dispersed in the paste. Each of the micro-RFID tags includes an integrated circuit (IC) having a memory and an antenna coupled to the IC.

In one embodiment, at least one of a binding agent, coalescing agent, wetting agent, and a carrier substance can be added to the paste. The paste can be adapted for use in a lithographic printing process. The plurality of micro-RFID tags can be dispersed substantially uniformly in the paste. The predetermined information can be written to the memory. In alternate embodiments, the color of the pigment can be cyan, magenta, yellow, black, or a color from the Pantone® color palette. The color of the pigment can correspond to a brand.

In another aspect, the invention is embodied in a branded ink. The branded ink includes a paste containing a pigment having a color that corresponds to a brand. A plurality of micro-RFID tags is dispersed in the paste. Each of the micro-RFID tags includes an integrated circuit (IC) having a memory and an antenna coupled to the IC. The memory contains predetermined information associated with the brand.

In one embodiment, the predetermined information associated with the brand is readable by a RFID reader positioned proximate to the branded ink. In one embodiment, the paste can also include at least one of a binding agent, coalescing agent, wetting agent, and a carrier substance. The paste can be adapted for use in a lithographic printing process. The plurality of micro-RFID tags can be dispersed substantially uniformly in the paste. In one embodiment, the largest dimension of each of the plurality of micro-RFID tags is less than 0.75 mm.

In yet another aspect, the invention is embodied in a coating. The coating includes a liquid applied during a post printing process. A plurality of micro-RFID tags is dispersed in the liquid, each of the micro-RFID tags includes an integrated circuit (IC) having a memory and an antenna coupled to the IC.

In one embodiment, the liquid is chosen from at least one of overprint varnish, aqueous coating, lamination, and ultraviolet (UV) coating. The information in the memory can be read by a RFID reader positioned proximate to the coating. The plurality of micro-RFID tags can be dispersed substantially uniformly in the liquid.

### BRIEF DESCRIPTION OF THE FIGURES

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

The above and further advantages of this invention may be better understood by referring to the following description in conjunction with the accompanying drawings, in which like numerals indicate like structural elements and features in various figures. Skilled artisans will appreciate that reference designators shown herein indicate components shown in a figure other than the one in discussion. For example, talking about a device 10 while discussing Figure A would refer to an element, 10, shown in figure other than Figure A.

FIG. 1 illustrates a block diagram of a micro-radio frequency identification (micro-RFID) tag having a substantially square shape according to one embodiment of the invention;

FIG. 2 illustrates a process for manufacturing a RFID ink according to one embodiment of the invention;

FIG. 3 illustrates a block diagram of a portion of a lithographic printing press according to one embodiment of the invention; and

FIG. 4 illustrates a block diagram of a portion of a digital printing device according to one embodiment of the invention.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description. For the purposes of conciseness, many conventional techniques and principles related to the manufacture of integrated circuits and inks, need not, and are not, described in detail herein.

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example, instance, or illustration” rather than “model,” or “deserving imitation.”

Technologies and concepts discussed herein relate to RFID ink for a lithographic printing process. According to one embodiment, the ink includes a paste containing a pigment. A plurality of micro-RFID tags is dispersed in the paste. Each of the micro-RFID tags includes an integrated circuit (IC) having a memory and an antenna coupled to the IC. Skilled artisans will appreciate that the inventive concepts described herein relative to RFID ink can also be applied to coatings and varnishes applied at the end of a printing process.

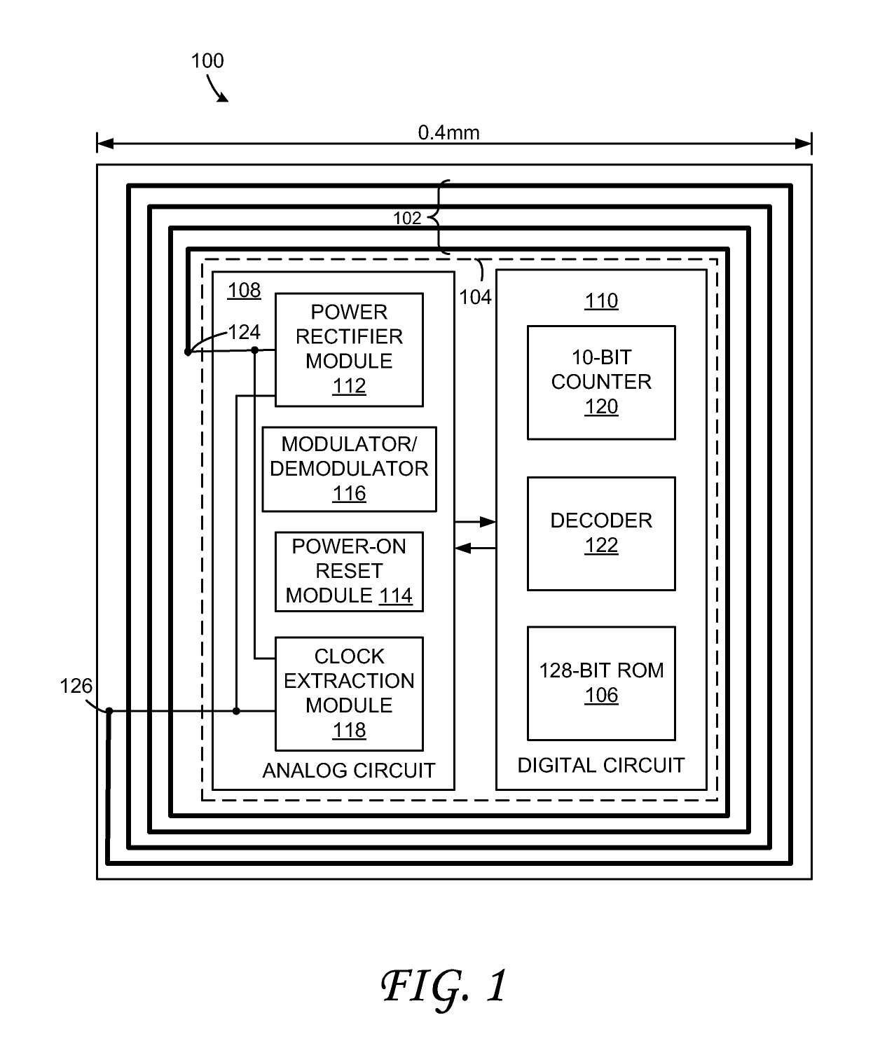

FIG. 1 illustrates a block diagram of a micro-radio frequency identification (micro-RFID) tag 100 having a substantially square shape according to one embodiment of the invention. In one embodiment, a dimension of each side of the tag is about 0.4 mm. In practice, the dimension of each side of the tag can be less than about 0.75 mm. The micro-RFID tag 100 includes an antenna 102 coupled to a small integrated chip (IC) 104. The IC 104 includes a memory 106 that can store a quantity of data, such as a universal product code (UPC). One such integrated chip 104 that can be used with the invention is made by Hitachi. Hitachi's micro-chip can store 128 bits of read-only data and communicates with an RFID reader (not shown) using a microwave frequency of 2.45 GHz. Other suitable micro-chips can also be used.

The micro-RFID tag 100 of the present invention can be either active, which means it includes a battery, or passive, which means it does not include a battery. In order to operate, a passive tag requires an external power source, such as a radio frequency (RF) signal from a RFID reader. In one embodiment, the micro-RFID tag 100 includes a built-in 100-pf capacitor formed by the gate oxide of a MOS transistor (not shown) as a power supply. The minimum operating voltage of the integrated circuit 104 in the micro-RFID tag 100 is about 0.5V.

The operating distance between the RFID reader and the micro RFID tag can depend on environmental factors as well as the strength of the RF signal from the RFID reader and the design of the antenna 102 in the micro-RFID tag 100, for example.

In general, RFID tags are designed to work at specific radio frequencies depending upon the physical characteristics of the tag antenna. For example, higher frequencies enable faster communication and typically larger read ranges. Lower frequencies perform better in the vicinity of interfering objects, such as metals. In general, the specific application will dictate the most suitable tag design.

In one embodiment, a micro-RFID tag 100 can be about 0.1 mm thick and about 0.4 mm in length on each side when the tag is square in shape. In other embodiments, the tag 100 can be any suitable shape, such as rectangular, and the length of its longest side can be equal to or less than 0.75 mm.

In one embodiment, the IC 104 of the micro-RFID tag 100 includes an analog circuit 108 and a digital circuit 110. The analog circuit 108 contains a power rectifier module 112, a power-on reset module 114, a modulator/demodulator 116 and a clock extraction module 118. The digital circuit 110 contains a 10-bit counter 120, a decoder 122, and a 128-bit read only memory (ROM) 106. In one embodiment, the ROM 106 can be substituted by a rewritable EEPROM memory (not shown).

The analog circuit 108 is coupled to the digital circuit 110. The analog circuit 108 is also coupled to antenna 102 via antenna terminals 124, 126. In one embodiment, the antenna 102 is tuned to the 2.45 GHz band frequency, used for radio communication signaling between the micro-RFID tag 100 and a RFID reader (not shown). The analog circuit 108 performs all analog processing for DC power, receive signal detection/demodulation, and transmit modulation. The digital circuit 110 decodes incoming data with the decoder 122, responds to commands from the RFID reader, reads the internal ROM memory 106, and encodes and transmits data to the modulator 116.

In one embodiment, the micro-RFID tag 100 can transmit the 128-bit data stored in 128-bit ROM 106 upon receiving the appropriate radio frequency from an RFID reader which is in range of the micro-RFID tag 100. The data can include product identification information, for example. In one embodiment, the micro-RFID tag 100 retains the 128-bit information in the ROM 106, which is written only once at manufacturing time. In this embodiment, the 128-bit information in the ROM 106 cannot be modified after the manufacturer's shipment of the micro-RFID tag 100.

The antenna 102 can be a dipole or a patch antenna. The power rectifier module 112 converts the input alternating voltage into a DC voltage, which is used by a series voltage regulator (not shown) to provide the regulated voltage required for the correct operation of the circuits 108, 110. The power rectifier module 112 is matched with the antenna 102 in order to ensure a maximum power transfer from the antenna 102 to the input of the power rectifier module 112. A backscatter modulator (not shown) is used to modulate the impedance seen by the antenna 102, when the micro-RFID tag 100 is transmitting.

In operation, an RFID reader (not shown) transmits a RF signal to the micro-RFID tag 100 (e.g., a 2.45 GHz microwave carrier signal), which is used to power on and activate the micro-RFID tag 100. This results in the micro-RFID tag 100 transmitting its stored 128-bit information via antenna 102. The RFID Reader receives and reads the transmitted data, recovering the 128-bit information which has been sent from the micro-RFID tag 100. In one embodiment, the antenna 102 is designed such that the micro-RFID tag 100 is readable by a RFID reader having a reader power of about 300 mW that is positioned within about 30 cm from the micro-RFID tag 100. As previously described, a RFID reader having a stronger reader power as well as a RFID tag having an optimized antenna design can increase the read range of the micro-RFID tag 100. Skilled artisans will appreciate that the data received by the RFID reader from the micro-RFID tag 100 can be uploaded to a network for further processing.

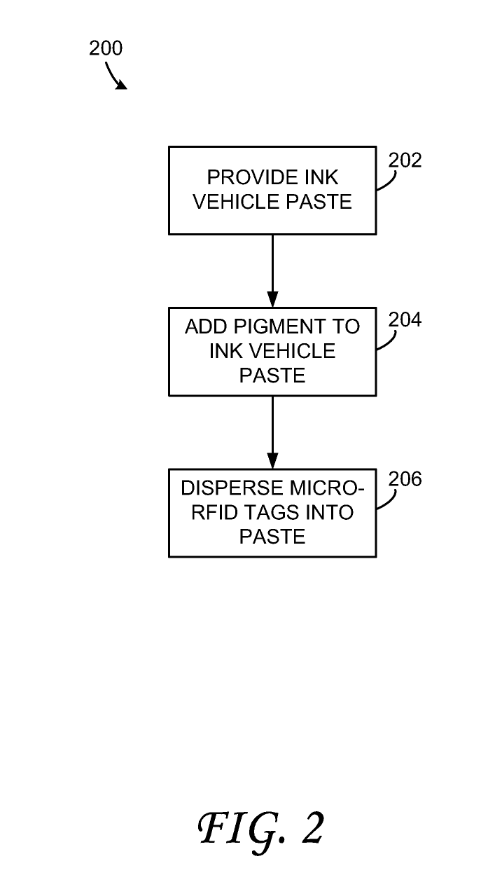

FIG. 2 illustrates a process 200 for manufacturing an RFID ink according to one embodiment of the invention. The RFID ink of the present invention can be fabricated by dispersing the micro-RFID tags of FIG. 1 into a conventional ink used in a commercial printing process, such as a lithographic printing process or a digital printing device. In one embodiment, a conventional lithography printing ink is designed according to several criteria, including the desired visual characteristics of the printed material, the type of printing process which will be used, the drying conditions of the ink, the substrate to which the ink must adhere, and the wear resistance of the ink.

The major component of a lithographic ink composition is known as a lithographic ink varnish or vehicle, which generally includes a resin and an oil component. The oil component mainly acts as a carrier for the resin component, although it can also affect the drying time of the ink composition. The resin component acts as a binding agent and binds the various ink components together and to the substrate once the ink is dried. The resin also enhances other properties of the ink, such as hardness, wear resistance, and drying time. There are two main classes of lithographic inks based on the method used for drying the ink: (1) an oleoresinous ink composition, which is dried by oxidation, absorption, or solvent evaporation, and (2) an acrylic ink composition, which is dried by radiation curing, such as UV or electron beam radiation. The present invention can use either ink composition.

The resins and oils in the ink composition of the present invention may include any natural and/or synthetic resins (e.g., phenolic, alkyd) and oils (e.g., linseed, tung) that are appropriate for use in lithographic inks One example ink composition of the present invention can include at least 4 ingredients: (1) between 75-90% of an oleoresinous component, which acts as both a vehicle for the other components and a quickset agent to promote a durable, wear resistant coating when dried, (2) between 10-25% of a matte agent, preferably fumed silica, to impart a matte finish, (3),between 0.1-10% of a cobalt catalyst to accelerate drying of the composition, and (4) between 0.1-10% of an etching agent, preferably isophorone, to condition the gloss surface to promote adherence of the ink composition. Optional ingredients include (5) a plasticizer to promote flexibility of the dried ink composition without cracking or blistering, (6) a manganese drying agent to aid in drying of the composition, and (7) a wax compound to increase rub resistance and to promote slip. Skilled artisans will appreciate that other suitable binding agents, coalescing agents, wetting agents, and carrier substances can also be used.

Skilled artisans will appreciate that varnishes are applied on a printing press like any other ink and can be tinted to create a special effect. Thus, the micro-RF tags 100 of the present invention can also be used with varnishes. Although gloss and matte varnishes are typically used as spot or overall coatings, they can also be incorporated in the process or spot color inks in order to provide a unique look to the presswork. Varnishes can be wet trapped (i.e. printed at the same time as the other inks) or dry trapped (i.e. printed as a second pass through the press after the other inks have dried).

Post process coatings can also include the micro-RFID tags 100 of the present invention. Coatings are applied to protect the printed pages from moisture, extreme temperatures, scuffs, scratches, and frequent handling. They can also be used to draw attention to a particular element on the page. There or many types of print coatings, for example, overprint varnish, aqueous coating, lamination, and UV coating.

Lamination comes in two types, film-based and liquid-based. Either a clear plastic film is laid down over the sheet of paper or a clear liquid is spread over the sheet and dries (or cures) like a varnish.

Ultraviolet (UV) coating is a substantially clear liquid that is spread over the paper like ink. It can be used as a spot covering to accent a particular image on the page or as an full page (flood) coating. UV coating gives more protection and shine than varnish or aqueous coating. UV coating is typically unsaturated polyester or polyacrylate based and when exposed to ultraviolet light, dries instantly. UV coating can be applied as a separate finishing operation as either a flood coating or (applied by screen printing) as a spot coating.

Aqueous coatings are water-based and are applied by an inking unit of the press or in a special coater. Aqueous has the advantage over varnish because it dries immediately and has glossy characteristic that falls between varnish and UV coating. Since aqueous can be applied over wet ink, can seal the printed sheet, and can dry immediately, it has the practical advantage of reducing handling time for trimming and other post-press operations. One disadvantage of an aqueous coating is that since it is water-based it can cause paper to curl, particularly on thinner paper weights.

In one embodiment, the method 200 of manufacturing the RFID ink of the invention includes a first step 202 of providing a ink vehicle having a consistency of paste. In a second step 204, a pigment is added to the paste to achieve a desired color of the ink. The color of the pigment can be one of the colors used in a four-color-process known in lithographic printing. Four inks are used in a four-color-process, three secondary colors and black. The ink colors are cyan, magenta, yellow and black, and are abbreviated as CMYK. Skilled artisans will appreciate that any color pigment, such as from the Pantone® color palette, can be used.

In a third step 206, a plurality of micro-RFID tags are dispersed in the paste. The micro-RFID tags include an integrated circuit (IC) having a memory and an antenna coupled to the IC. In one embodiment, the plurality of micro-RFID tags is dispersed substantially uniformly throughout the paste.

In one embodiment, pre-determined information is stored in the memory of each micro-RFID tag prior to dispersing the RFID tags in the paste. Alternatively, information could be written to the memory after the RFID ink is manufactured. In this embodiment, an RFID reader having write capability is positioned proximate to the RFID ink. A writable memory in each micro-RFID tag stores information received from the RFID reader.

In one embodiment, the ink color can correspond to a brand. For example, the ink color can be the orange color associated with The Home Depot® brand or the brown color associated with United Parcel Service® brand. In this embodiment, information related to the brand can be preloaded in the memory of each micro-RFID tag in the plurality of micro-RFID tags. In this embodiment, the RFID ink is used as a brand ink for association with a specific brand. For example, according to the invention, if a brand ink is used to print a graphic on a cereal box, the memory in each of the micro-RFID tags dispersed in that brand ink can store identification information about the cereal, such as brand, type, size, price, etc. The identification information can be acquired by an RFID reader at the point of sale, for example. In one embodiment, a shopping cart having disparate items, each printed with a corresponding RFID ink, can be scanned substantially simultaneously by a RFID reader at a checkout location in a store.

In one embodiment, a barcode can be printed on an item using the RFID ink. In this embodiment, the memories of the micro-RFID tags within the RFID ink can contain the same information that is encoded in the printed barcode. Thus, the barcode can be read using a barcode reader and/or a RFID reader.

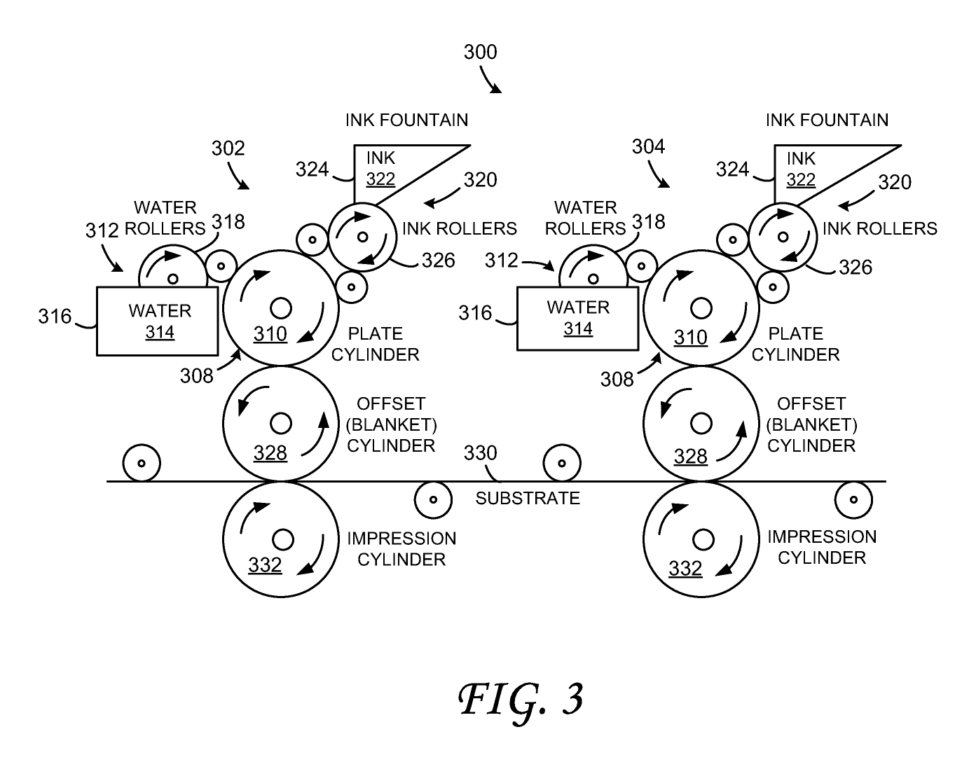

FIG. 3 illustrates a block diagram of a portion of an offset lithographic printing press 300 according to one embodiment of the invention. The offset lithographic printing press 300 is illustrated with a first printing unit 302 and a second printing unit 304. Skilled artisans will appreciate that additional printing units (not shown) can be added depending on the number of colors to be printed. In one embodiment, a press supporting a four-color-process uses cyan, magenta, yellow and black (CMYK). The

RFID ink of the present invention can be used in the offset lithographic printing press 300. Skilled artisans will appreciate that the lithographic printing process described herein includes conventional printing processes, such as offset, Gravuor and flexographic processes. However, the inventive concepts herein can also be applied to a printing press using a digital printing process.

The offset lithographic printing press 300 operates on the principal of immiscibility of polar and non-polar fluids. Printing plates 308 that are used for offset lithographic printing are prepared with areas corresponding to printed areas having a hydrophobic property and areas corresponding to non-printed areas having a hydrophilic property. The printing plate 308 is mounted on a cylinder 310, and the cylinder 310 is rotated past a water delivery system 312 that coats the printing plate 308 with water 314. For example, the water delivery system 312 can include a water tank 316 and water rollers 318. Alternatively, a water fountain (not shown) can also be used. Water 314 stays on those areas of the printing plate 308 that are hydrophilic and is repelled from the hydrophobic areas. The printing plate 308 is then rotated further to an ink delivery mechanism 320 that applies a layer of ink 322 Ink 322 is delivered to the printing plate 308 though an ink train. The ink train includes a fountain 324 containing bulk ink 322 and a series of rollers 326 that apply shear force, spread the ink, and physically move the resultant ink film to a nip where it is transferred to the printing plate 308. Shear force is used to level the ink, meter the ink, and reduce its viscosity sufficiently for further processing, including transfer to the printing plate 308, transfer to an offset cylinder 328, transfer to the substrate 330, and levelling on the substrate 330. The offset cylinder 328 (herein called the blanket cylinder) is usually covered with a rubber “blanket.” As previously described, offset lithographic inks are generally high viscosity pastes that are shear thinned in the ink train.

As previously described, the ink 322 used by the offset lithographic press 300 is oil-based and hydrophobic. Accordingly, the ink 322 adheres to the hydrophobic areas of the printing plate 308 having no water and does not adhere to the hydrophilic areas that are coated with water 314.

After the printing plate 308 is coated with ink 322 in selected areas of the plate 308, the plate 308 is rotated to a nip with the blanket cylinder 328. The roller nip is critical for offset printing since it both transports and processes the ink and water solution. The substrate 330 is transported through the nip between the blanket cylinder 328 and an impression cylinder 332 in proper registration with the ink image on the blanket cylinder 328. Ink 322 from the blanket cylinder 328 is transferred to the substrate 330 using pressure from the impression cylinder 332.

After the ink 322 has adhered to the surface of the substrate 330, the substrate 330 is then transported through a region (not shown) where the ink 322 cures. In one embodiment, a chain grips the edges of the substrate 330. In one embodiment, a curing device (not shown) facilitates the curing of the ink 332 to make it dry enough to stack printed substrates 330 without transferring ink to the back of an overlying sheet. There are several different forms of curing devices including forced air drying tunnels, infrared (IR) emitters, electron beam emitters, and ultraviolet (UV) emitters. Most conventional offset lithographic inks are heat-cured. Skilled artisans will appreciate that the inventive concepts described herein relative to RFID ink can also be applied to coatings and varnishes applied at the end of the printing process.

There are two types of printing presses. One type is a sheet-fed press. In sheet-fed presses and duplicators, individual sheets are carried from the feeder, through one or more printing stations, through a drying or curing apparatus, and stacked in an output bin. The second type is a web-fed press. In a web-fed press, the printing media is supplied to the printing press in continuous web and carried in a web throughout the printing process. Output from web-fed presses and duplicators may either be wound into a roll for further processing or can be cut, scored, folded, and/or stacked.

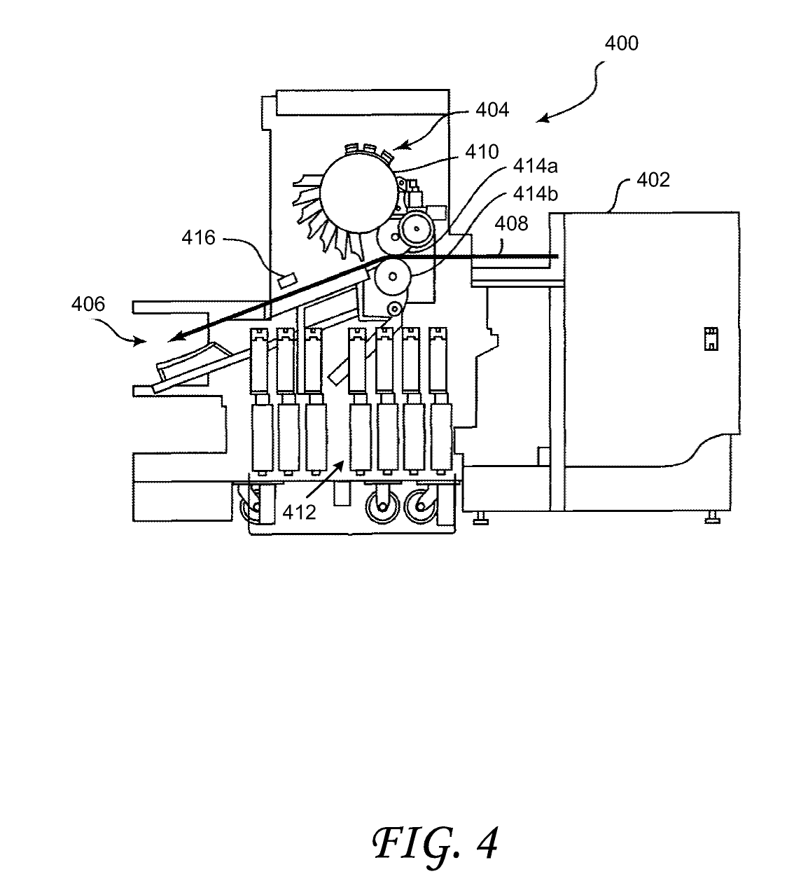

FIG. 4 illustrates an exemplary configuration of a digital printing device 400 configured to implement digital imaging operations using ink having a plurality of micro-RFID tags 100. In one embodiment, imaging device 400 can be a digital imaging device configured to access or generate digital image data to form hard color images upon media, such as paper, labels, transparencies, etc. For example, the imaging device 400 can be configured as a digital press, such as an HP Indigo 5000 digital printing press available from Hewlett-Packard Company.

Device 400 can include a media feed unit 402, an image engine 404 and an output handling unit 406, as well as other components not shown. Media is transferred along a media path 408 from media feed unit 402 to image engine 404 for the formation of hard images and subsequently outputted to output handling unit 406.

In one embodiment, the image engine 404 is configured to implement electrophotographic imaging operations to form latent images responsive to image data and develop the latent images using RFID inks having one or more different colors. Other embodiments of image engine 404 for forming images upon media are also possible. In another embodiment, image engine 404 uses a photoconductive drum 410 to form and develop latent images using the RFID inks The described exemplary image engine 404 receives the RFID ink from a reservoir 412 configured to store the RFID ink. A plurality of reservoirs 412 can store a plurality the different colored inks The developed color images are transferred from photoconductive drum 410 via imaging drums 414a, 414b to media (not shown) within the media path 408. The imaging drum 408a adjacent to the photoconductive drum 410 can be referred to as a blanket drum, and the imaging drum 408b adjacent to the media path 408 can be referred to as an impression drum.

A sensor 416 is positioned downstream of the image engine 404 along the media path 408 and is configured to monitor hard images formed upon media by image engine 404. In other embodiments, the sensor 416 can be positioned at other locations (e.g., positioned and configured to monitor images upon photoconductive drum 410). The sensor 416 can be referred to as an inline sensor.

Skilled artisans will appreciate that additional components of the digital printing device 400 are required although not shown. For example, the digital printing device 400 also includes a communications interface, at least one processor, memory, and a user interface that are electrically coupled together and with image engine 404 and sensor 416, for example, via a communications bus (not shown). Other configurations are possible including more, less and/or alternative components.

In one embodiment, the communications interface (not shown) is configured to implement communications of the digital printing device 400 with respect to external devices (not shown). For example, the communications interface can be configured to communicate information bi-directionally with respect to external devices. The communications interface can be implemented as a network interface card (NIC), serial or parallel connection, USB port, Firewire interface, flash memory interface, or any other suitable arrangement for communicating with respect to the digital printing device 400. In one embodiment, the communications interface can be coupled to a host or a network. In another embodiment, the digital printing device 400 may operate as a stand-alone device without a host or network.

In one embodiment, the processor (not shown) is arranged to process data (e.g., access and process digital image data corresponding to a color image to be formed as a hard image upon media), control data access and storage, issue commands, monitor imaging operations and/or control imaging operations (e.g., control imaging operations and/or implement calibration operations responsive to monitoring as described below in exemplary embodiments). The processor can include circuitry configured to implement desired programming provided by the memory. For example, the processor can execute executable instructions including, for example, software and/or firmware instructions, and/or hardware circuitry. Exemplary embodiments of processors include hardware logic, PGA, FPGA, ASIC, state machines, and/or other structures alone or in combination with the processor.

The memory (not shown) is configured to store programming such as executable code or instructions (e.g., software and/or firmware), electronic data (e.g., image data), databases, look up tables, or other digital information useful to the operation of the digital printing device 400. The memory includes any device that can contain, store, or maintain programming, data and/or digital information for use by or in connection with the processor. For example, the memory can include any one of physical media such as electronic, magnetic, optical, electromagnetic, infrared or semiconductor media, such as a magnetic computer diskette, zip disk, hard drive, random access memory, read only memory, flash memory, cache memory, and/or other configurations capable of storing programming, data, or other digital information.

The digital printing device 400 can be operated using programming stored within the memory and/or communicated via a network or using other transmission media and configured to control the processor. For example, programming may be provided through a communications network (e.g., the Internet and/or a private network), wired electrical connection, optical connection and/or electromagnetic energy, for example, via the communications interface, or provided using other appropriate communication structure.

A user interface is configured to interact with a user, including conveying data to a user (e.g., displaying data for observation by the user, audibly communicating data to a user, etc.) as well as receiving inputs from the user (e.g., tactile input, voice instruction, etc.). Accordingly, in one exemplary embodiment, the user interface can include a display (e.g., cathode ray tube, LCD, etc.) configured to depict visual information and an audio system as well as a keyboard, mouse and/or other input device.

In one embodiment, the digital printing device 400 combines inline color measurement (via sensor 30) with job and measurement analysis and a color feedback algorithm. The job and measurement analyses indicates whether the measured color of the printed image is within color consistency tolerances, and the color feedback algorithm adjusts or calibrates the digital printing device 400 to maintain the measured color within the tolerances.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An ink, comprising:
a paste containing a pigment; and
a plurality of micro-RFID tags dispersed in the paste, each of the micro-RFID tags comprising an integrated circuit (IC) having a memory and an antenna coupled to the IC.

2. The ink of claim 1, wherein a color of the pigment corresponds to a brand.

3. The ink of claim 1, wherein a color of the pigment is chosen from the group consisting of cyan, magenta, yellow and black.

4. The ink of claim 1, wherein the paste further comprises at least one of a binding agent, coalescing agent, wetting agent, and a carrier substance.

5. The ink of claim 1, wherein the paste is adapted for use in at least one of a lithographic printing process and a digital printing process.

6. The ink of claim 1 further comprising an impedance matching circuit positioned in the antenna for matching impedance between the IC and the antenna.

7. The ink of claim 1, wherein information in the memory is readable by a RFID reader positioned proximate to the ink.

8. The ink of claim 1, wherein the plurality of micro-RFID tags is dispersed substantially uniformly in the paste.

9. The ink of claim 1, wherein the memory contains predetermined information.

10. The ink of claim 1, wherein a largest dimension of each of the plurality of micro-RFID tags is less than 0.75 mm.

11. A method for manufacturing ink, comprising:
adding a pigment to a paste; and
dispersing a plurality of micro-RFID tags in the paste, the micro-RFID tags comprising an integrated circuit (IC) having a memory and an antenna coupled to the IC.

12. The method of claim 11 further comprising adding at least one of a binding agent, coalescing agent, wetting agent, and a carrier substance to the paste.

13. The method of claim 11 further comprising writing information to the memory.

14. The method of claim 11, wherein the plurality of micro-RFID tags is dispersed substantially uniformly in the paste.

15. The method of claim 11, wherein a color of the pigment corresponds to a brand.

16. The method of claim 11, wherein a color of the pigment is chosen from the group consisting of cyan, magenta, yellow and black.

17. A branded ink, comprising:
a paste containing a pigment having a color that corresponds to a brand; and
a plurality of micro-RFID tags dispersed in the paste, each of the micro-RFID tags comprising an integrated circuit (IC) having a memory and an antenna coupled to the IC, the memory containing predetermined information associated with the brand.

18. The branded ink of claim 17, wherein the predetermined information associated with the brand is readable by a RFID reader positioned proximate to the branded ink.

19. The branded ink of claim 17, wherein the paste further comprises at least one of a binding agent, coalescing agent, wetting agent, and a carrier substance.

20. The branded ink of claim 17, wherein the paste is adapted for use in at least one of a lithographic printing press and a digital printing device.

21. The branded ink of claim 17, wherein the plurality of micro-RFID tags is dispersed substantially uniformly in the paste.

22. The branded ink of claim 17, wherein a largest dimension of each of the plurality of micro-RFID tags is less than 0.75 mm.

23. A coating, comprising:
a liquid applied during a post printing process; and
a plurality of micro-RFID tags dispersed in the liquid, each of the micro-RFID tags comprising an integrated circuit (IC) having a memory and an antenna coupled to the IC.

24. The coating of claim 23, wherein the liquid is chosen from at least one of overprint varnish, aqueous coating, lamination, and ultraviolet (UV) coating.

25. The coating of claim 23, wherein information in the memory is readable by a RFID reader positioned proximate to the coating.

26. The coating of claim 23, wherein the plurality of micro-RFID tags is dispersed substantially uniformly in the liquid.
